(19) United States
(12) Patent Application Publication
(10) Pub. No.: US 2017/0098405 A1
(43) Pub. Date: Apr. 6, 2017

(54) DISPLAY DEVICE

(71) Applicant: Sharp Kabushiki Kaisha, Sakai City, Osaka (JP)

(72) Inventor: Ryohei KOIZUMI, Osaka (JP)

(73) Assignee: Sharp Kabushiki Kaisha, Sakai City, Osaka (JP)

(21) Appl. No.: 15/128,254

(22) PCT Filed: Apr. 30, 2015
(86) PCT No.: PCT/JP2015/063012

§ 371 Date: Sep. 22, 2016

(30) Foreign Application Priority Data
May 30, 2014 (JP) 2014-112726

(51) Int. Cl. G09G 3/20; G09G 3/34

(52) U.S. Cl. CPC G09G 3/2022; G09G 3/2085; G09G 3/3413; G09G 3/2003; G09G 2320/0233

(57) ABSTRACT

In a display device 10, light-emitting subframe periods are selected such that one or more light-emitting subframe periods and one or more non-light-emitting subframe periods differ between light-emitting patterns A to D corresponding to pixels A to D. In the light-emitting pattern A, selection is made such that the number of light-emitting subframe periods is largest, in the light-emitting pattern B, selection is made such that light-emitting subframe periods differ from those in the light-emitting pattern A as much as possible, and in the light-emitting patterns C and D, selection is made such that only the longest light-emitting subframe periods in the light-emitting patterns A and B differ. Hence, a spatial location of the occurrence of contouring can be distributed, suppressing contouring. By this, a display device using a time division gray scale system is provided that can represent high gray scale and that sufficiently suppresses the occurrence of contouring.

### TECHNICAL FIELD

The present invention relates to a display device, and more particularly to a display device that performs display using a time division gray scale system.

### BACKGROUND ART

In recent years, there has been a display in which micro-shutter elements (hereinafter, simply referred to as “shutters”) are arranged in a matrix form. The shutters can take only two states, either light transmission or light blockage. Thus, many of the shutters have a structure in which light transmittance cannot be controlled by an applied voltage, as common liquid crystal elements do. Hence, there is an example in which, for gray scale display on a display, one frame period (in the following, a color frame period for displaying a certain color is also referred to as one frame period) is divided into a plurality of subframe periods, and the length of a lighting period included in each subframe period is typically weighted according to a binary system. By appropriately selecting lighting periods set in this manner and controlling, by the shutters, the transmission and blockage of radiated light, gray scale is represented on a pixel-by-pixel basis. Such a gray scale representation system is also referred to as time division gray scale system.

The time division gray scale system is known to cause a phenomenon where a bright-dark boundary that does not actually exist (hereinafter, referred to as “contouring”) is seen. FIG. 14 is a diagram for describing the occurrence of contouring in a conventional example.

FIG. 14 shows a light-emitting state of each subframe period for when the gray scale of two pixels A and B adjacent to each other in a row direction is displayed using the time division gray scale system. Of the subframe periods in the drawing, hatched subframe periods indicate non-light-emitting periods and other periods indicate light-emitting periods. That is, in the pixel A, 63 gray scale (a gray scale value of 63) is displayed, and in order to implement the gray scale, of a plurality of subframe periods into which one frame period is divided, subframe periods from the one having a length of one unit to the one having a length of 32 units, sequentially from the left in the drawing, are brought to the light-emitting state and the remaining subframe periods having a length of 64 units and a length of 128 units are brought to the non-light-emitting state. Note that for convenience of description, the length of each unit is set appropriately, and a number indicating the length is described in the drawing. Note also that in the pixel B, 64 gray scale (a gray scale value of 64) is displayed, and in order to implement the gray scale, a subframe period having a length of 64 units is brought to the light-emitting state and other subframe periods are brought to the non-light-emitting state.

In addition, a dotted-line arrow in the drawing indicates a state of the movement of a line of sight. Specifically, it indicates that the line of sight has moved from the pixel B to the pixel A during one frame period. As shown in the drawing, subframe periods in the non-light-emitting state are recognized with the movement of the line of sight; however, since the subframe periods are very short, the subframe periods cannot be recognized individually, and also since the distance of the movement of the line of sight is small, with the movement of the line of sight, the brightness of the pixel A and the brightness of the pixel B may be merged and recognized. Specifically, when the target of the line of sight is present in the pixel B, only the subframe periods in the non-light-emitting state are recognized, and when the target of the line of sight is present in the pixel A, too, only the subframe periods in the non-light-emitting state are recognized. As a result, despite the fact that both of the two pixels A and B are emitting light, the pixels A and B are erroneously recognized as pixels that are not emitting light at all, and as a result, a dark contour may be seen. In addition, such erroneous recognition may also occur when the line of sight moves from the pixel A to the pixel B. In that case, the pixels A and B may be erroneously recognized as, for example, 127 gray scale (a gray scale value of 127) pixels, and as a result, a bright contour may be seen.

FIG. 15 is a diagram showing such contouring which is visualized based on simulation computation. Simulation in this FIG. 15 is computed such that brightnesses that are recognized when the line of sight moves as shown in FIG. 14 are represented as the actual brightnesses of pixels. As shown in this FIG. 15, it can be seen that, when a sphere whose luminance gradually changes is displayed, contouring occurs near predetermined gray scales.

It is known that such contouring based on erroneous recognition also occurs in a display device using a PDP (Plasma Display Panel) system which adopts the time division gray scale system, and conventionally, measures are taken to reduce the contouring.

For example, Japanese Laid-Open Patent Publication No. 10-31455 discloses a configuration of a display device using a PDP system in which sustain periods which are light-emitting time in each subfield period are set to substantially the same length, and non-light-emitting periods are set to different lengths. In this configuration, since the sustain periods have substantially the same length, contouring is reduced.

In addition, for example, Japanese Laid-Open Patent Publication No. 11-52912 discloses a configuration of a display device using a PDP system in which, upon setting whether to allow each display element to emit light on a subframe-by-subframe basis, according to an output gray scale level, luminance is weighted such that a difference between the highest weight and the second highest weight is smaller than the lowest weight. In this configuration, light-emitting states in one frame are averaged by a plurality of subframes having similar weights, by which contouring is reduced.

Furthermore, for example, Japanese Laid-Open Patent Publication No. 2008-51949 discloses a configuration of a display device using a PDP system in which two types of subframe lighting patterns (mode A and B) are disposed in spatially different regions in a field (in a staggered manner), and setting is performed such that a lack of subfields to light up is present only in one mode in all lighting steps. In this configuration, since a lack of subfields to light up is reduced, contouring is reduced.

Moreover, Japanese Laid-Open Patent Publication No. 2012-242435 discloses a configuration of a display in which one frame period is divided into a first group to which belong subframe periods whose light passage periods have the same length and a second group to which belong subframe periods whose light passage periods are shorter in length than those in the first group and different from each other, and of the subframe periods belonging to the first group, subframe periods having light passage periods are disposed so as to increase from a midway of one frame period toward a starting point and an ending point as the gray scale increases. In this configuration, since light passage periods gather at the center of one frame period, contouring is reduced.

### PRIOR ART DOCUMENTS

### Patent Documents

[Patent Document 1] Japanese Laid-Open Patent Publication No. 10-31455

[Patent Document 2] Japanese Laid-Open Patent Publication No. 11-52912

[Patent Document 3] Japanese Laid-Open Patent Publication No. 2008-51949

[Patent Document 4] Japanese Laid-Open Patent Publication No. 2012-242435

### SUMMARY OF THE INVENTION

### Problems to be Solved by the Invention

Here, the above-described device configuration described in Japanese Laid-Open Patent Publication No. 10-31455 has a problem that the number of representable gray scales becomes very small. Regarding this, in the above-described device configuration described in Japanese Laid-Open Patent Publication No. 11-52912, even if the number of representable gray scales becomes relatively large, there is a problem that high gray scale representation such as 256 gray scale cannot be performed.

In addition, the above-described device configuration described in Japanese Laid-Open Patent Publication No. 2008-51949 likewise has a problem that high gray scale representation cannot be performed, and when high gray scale representation is performed using a plurality of pixels, which is described in another embodiment, there is a problem that high definition display cannot be performed.

Regarding this, in the above-described device configuration described in Japanese Laid-Open Patent Publication No. 2012-242435, high gray scale representation can be performed, but contouring may occur in a case of a specific gray scale arrangement, and thus, it cannot be said that the occurrence of contouring is sufficiently suppressed. In addition, in the above-described other device configurations, too, since contouring may occur, it cannot be said that the occurrence of contouring is sufficiently suppressed.

An object of the present invention is therefore to provide a display device using a time division gray scale system that is capable of performing high gray scale representation and that sufficiently suppresses the occurrence of contouring for all gray scales.

### Means for Solving the Problems

According to a first aspect of the present invention, there is provided a display device that performs pixel-by-pixel gray scale display by dividing a unit frame period into subframe periods with a plurality of types of length and controlling whether to allow a pixel to emit light, on a subframe-period-by-subframe-period basis, the display device including: a display panel including a plurality of pixel formation portions arranged in a matrix form in a column direction and a row direction; a display control circuit that outputs, based on an input signal, data signals for controlling whether to allow each of the plurality of pixel formation portions to emit light, on a subframe-period-by-subframe-period basis; and a drive circuit that drives the plurality of pixel formation portions based on the data signals, wherein the display control circuit: has, for each gray scale, first to fourth different light-emitting patterns as light-emitting patterns indicating whether to allow a pixel to emit light during each of the plurality of subframe periods included in the unit frame period; and assigns two or more of the first to fourth light-emitting patterns to four pixel formation portions included in each of sets, each of the sets including four pixel formation portions arranged in a matrix form and two of the four pixel formation portions being arranged adjacent to each other in the column direction and the row direction, and outputs, as the data signals, signals for controlling whether to allow each of the pixel formation portions to emit light according to the assigned light-emitting patterns.

According to a second aspect of the present invention, in the first aspect of the present invention, the display control circuit assigns the first to fourth light-emitting patterns to the four pixel formation portions such that, when there are a plurality of longest subframe periods in the first to fourth light-emitting patterns and when a pixel is allowed to emit light during at least one of the plurality of longest subframe periods and a pixel is not allowed to emit light during the at least one of the plurality of longest subframe periods, the longest subframe period during which a pixel is allowed to emit light differs between two pixel formation portions adjacent to each other in the row direction and differs between two pixel formation portions adjacent to each other in the column direction.

According to a third aspect of the present invention, in the second aspect of the present invention, the display control circuit assigns the first to fourth light-emitting patterns having the longest light-emitting subframe periods near a center of the unit frame period, to the four pixel formation portions.

According to a fourth aspect of the present invention, in the second aspect of the present invention, the display control circuit assigns the first light-emitting pattern having a largest number of light-emitting subframe periods, the second light-emitting pattern having a largest number of light-emitting subframe periods that differ from the light-emitting subframe periods in the first light-emitting pattern, the third light-emitting pattern that differs from the first light-emitting pattern only in the longest light-emitting subframe period, and the fourth light-emitting pattern that differs from the second light-emitting pattern only in the longest light-emitting subframe period, to the four pixel formation portions, the light-emitting subframe periods being subframe periods during which a pixel is allowed to emit light.

According to a fifth aspect of the present invention, in the first aspect of the present invention, the display control circuit assigns the first to fourth light-emitting patterns to the four pixel formation portions such that one or more of the first to fourth light-emitting patterns differ between two consecutive unit frame periods.

According to a sixth aspect of the present invention, in the fifth aspect of the present invention, the display control circuit assigns the first to fourth light-emitting patterns to the four pixel formation portions such that one or more of the first to fourth light-emitting patterns differ between four consecutive unit frame periods.

According to a seventh aspect of the present invention, in the first aspect of the present invention, the display control circuit assigns the first to fourth light-emitting patterns to a pixel formation portion group included in each of sets, each of the sets including a pixel formation portion group where one or more pixel formation portions adjacent to any of the four pixel formation portions are added.

According to an eighth aspect of the present invention, in the seventh aspect of the present invention, the display control circuit further has one or more light-emitting patterns differing from the first to fourth light-emitting patterns, and assigns the five or more light-emitting patterns to the pixel formation portion group.

According to a ninth aspect of the present invention, there is provided a display method that performs pixel-by-pixel gray scale display by dividing a unit frame period into subframe periods with a plurality of types of length and controlling whether to allow a pixel to emit light, on a subframe-period-by-subframe-period basis, the display method including: a display controlling step of outputting, based on an input signal, data signals to a display panel including a plurality of pixel formation portions arranged in a matrix form in a column direction and a row direction, the data signals controlling whether to allow each of the plurality of pixel formation portions to emit light, on a subframe-period-by-subframe-period basis; and a driving step of driving the plurality of pixel formation portions based on the data signals, wherein the display controlling step: has, for each gray scale, first to fourth different light-emitting patterns as light-emitting patterns indicating whether to allow a pixel to emit light during each of the plurality of subframe periods included in the unit frame period; and assigns two or more of the first to fourth light-emitting patterns to four pixel formation portions included in each of sets, each of the sets including four pixel formation portions arranged in a matrix form and two of the four pixel formation portions being arranged adjacent to each other in the column direction and the row direction, and outputs, as the data signals, signals for controlling whether to allow each of the pixel formation portions to emit light according to the assigned light-emitting patterns.

### Effects of the Invention

According to the first aspect of the present invention, first to fourth different light-emitting patterns are provided for each gray scale and assigned to four pixel formation portions. Thus, light-emitting subframe periods are selected such that one or more light-emitting subframe periods and one or more non-light-emitting subframe periods differ between the light-emitting patterns. Accordingly, a spatial location of the occurrence of contouring can be distributed, enabling to suppress overall contouring.

According to the second aspect of the present invention, since the longest subframe period during which a pixel is allowed to emit light differs between two adjacent pixel formation portions, a light emission barycenter is distributed. As a result, a point of the occurrence of contouring can be distributed.

According to the third aspect of the present invention, since the longest light-emitting subframe periods are present near the center of the unit frame period, a temporal light emission barycenter does not move, and thus, a point of the occurrence of contouring can be distributed to a location other than the center (to be exact, a point in time other than the center). As a result, overall contouring can be suppressed.

According to the fourth aspect of the present invention, since the positions of light-emitting subframe periods differ between four pixel formation portions by the first to fourth light-emitting patterns, the possibility that the line of sight moves only to a non-light-emitting subframe period portion decreases (i.e., when the line of sight moves, the overall amount of gray scale change decreases). As a result, contouring can be suppressed.

According to the fifth aspect of the present invention, since one or more light-emitting patterns differ between two consecutive unit frame periods, the location of the occurrence (the point in time of the occurrence) of contouring can be distributed temporally, too. As a result, the occurrence of contouring can be further suppressed.

According to the sixth aspect of the present invention, the same effect as that provided in the fifth aspect can be provided for four consecutive unit frame periods.

According to the seventh aspect of the present invention, since the number of pixel formation portions to be assigned increases, a spatial location of the occurrence of contouring can be further distributed, enabling to further suppress contouring.

According to the eighth aspect of the present invention, since the number of light-emitting patterns increases, contouring can be further suppressed.

According to the ninth aspect of the present invention, the same effect as that provided in the first aspect can be provided in an aspect of a method.

### BRIEF DESCRIPTION OF THE DRAWINGS

FIG. 1 is a block diagram showing a configuration of a display device that adopts a field sequential system and a time division gray scale system, according to a first embodiment of the present invention.

FIG. 2 is a diagram showing display colors and lighting periods thereof in respective color frame periods in the above-described embodiment.

FIG. 3 is a diagram showing four light-emitting patterns corresponding to four pixels from a pixel A to a pixel D during a lighting period included in an R color frame period in the above-described embodiment.

FIG. 4 is a diagram partially showing exemplary disposition of the light-emitting patterns of pixels in the above-described embodiment.

FIG. 5 is a diagram showing contouring which is visualized based on simulation computation in the above-described embodiment.

FIG. 6 is a diagram showing contouring which is visualized based on simulation computation for a case of performing gray scale display using the same light-emitting pattern for all pixels, unlike the present embodiment.

FIG. 7 is a diagram showing an example of correspondences between pixels and light-emitting patterns for a first frame and a second frame in a second embodiment of the present invention.

FIG. 8 is a diagram showing an example in which correspondences between pixels and light-emitting patterns are changed by rotation from a first frame to a fourth frame in the present embodiment.

FIG. 9 is a diagram showing an example in which correspondences between pixels and light-emitting patterns are randomly changed from a first frame to a fourth frame in the present embodiment.

FIG. 10 is a diagram showing an example of correspondences between 16 pixels adjacent to each other in a row direction and a column direction and four light-emitting patterns in a third embodiment of the present invention.

FIG. 11 is a diagram showing an example of correspondences between pixels and light-emitting patterns for a first frame and a second frame in the present embodiment.

FIG. 12 is a diagram showing an example of correspondences between 25 pixels adjacent to each other in a row direction and a column direction and five light-emitting patterns in the present embodiment.

FIG. 13 is a diagram showing an example of correspondences between nine pixels adjacent to each other in a row direction and a column direction and nine light-emitting patterns in the present embodiment.

FIG. 14 is a diagram for describing the occurrence of contouring in a conventional example.

FIG. 15 is a diagram showing contouring which is visualized based on simulation computation in the conventional example.

### MODES FOR CARRYING OUT THE INVENTION

### 1. First Embodiment

### 1.1 Configuration of a Display Device

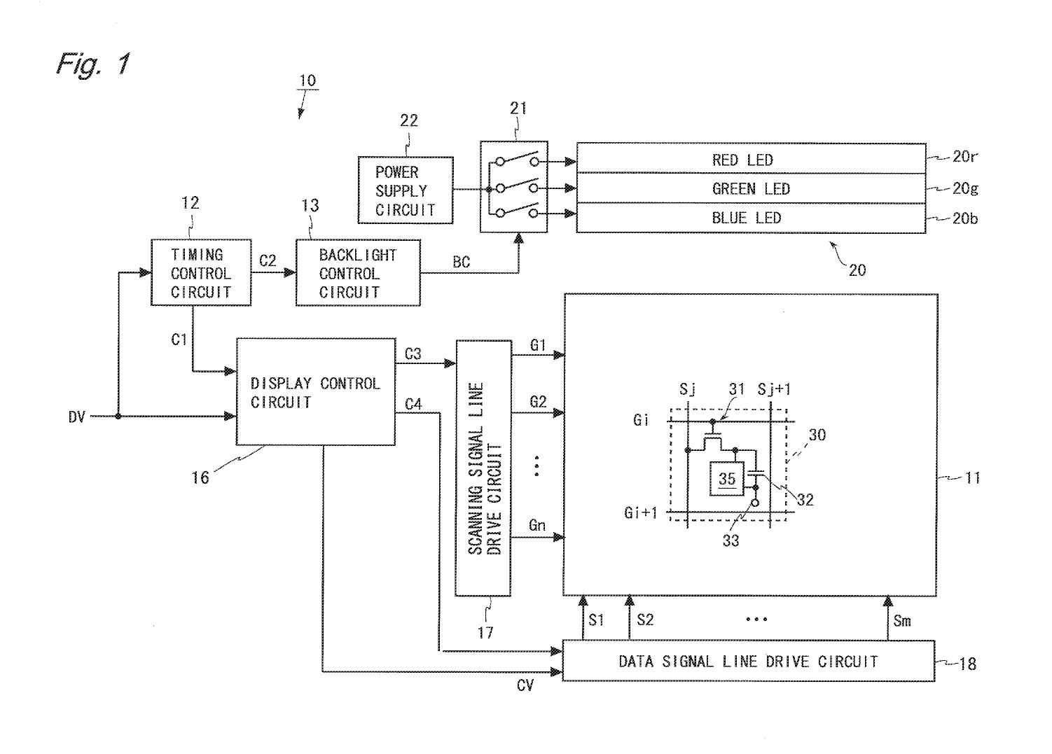

FIG. 1 is a block diagram showing a configuration of a display device 10 that adopts a field sequential system and a time division gray scale system, according to a first embodiment of the present invention. The display device 10 shown in FIG. 1 performs color display by a field sequential color system in which one frame period is divided into three color frame periods for displaying three RGB colors one by one. In addition, each color frame period includes subframe periods divided into a plurality of predetermined types of length. By appropriately selecting the subframe periods, time-division gray scale display is implemented. The display device 10 includes a display panel 11, a timing control circuit 12, a backlight control circuit 13, a display control circuit 16, a scanning signal line drive circuit 17, a data signal line drive circuit 18, a backlight unit 20, a switch group 21, and a power supply circuit 22. Note that the scanning signal line drive circuit 17 and the data signal line drive circuit 18 together may be hereinafter simply referred to as drive circuit.

In the following description, it is assumed that one frame period is 1/60 second and each of a red component (red gray scale value), a green component (green gray scale value), and a blue component (blue gray scale value) of an input signal which is inputted to the display device 10 from an external source is 8-bit data.

The display panel 11 includes a plurality of (m) data signal lines S1 to Sm, a plurality of (n) scanning signal lines G1 to Gn, and a plurality of (m×n) pixel formation portions 30 provided corresponding to the respective intersections of the plurality of data signal lines S1 to Sm and the plurality of scanning signal lines G1 to Gn. Each pixel formation portion 30 includes a TFT 31 that functions as a switching element; a common electrode 33 that provides a reference potential; a signal holding capacitance 32 connected at its one end to a drain terminal of the TFT 31 and connected at its other end to the common electrode 33; and an optical modulation element 35 connected in parallel to the signal holding capacitance 32. In addition, the TFT 31 is connected at its gate terminal to a scanning signal line Gi (1≦i≦n) and connected at its source terminal to a data signal line Sj (1≦j≦m).

Note that the optical modulation element 35 includes an optical shutter that is fabricated, for example, based on photolithographic techniques and that has a fine structure including an electromagnetically movable portion, and operates to allow light from the backlight unit 20 to be transmitted therethrough during a predetermined subframe period during which light emission is to be performed, and to block the light during other periods. The configuration and operation of such an optical modulation element 35 are known and thus a detailed description thereof is omitted. If the optical modulation element 35 is an optical modulation element that functions as a shutter such as that described above, then various known configurations such as a liquid crystal element can be adopted as long as the optical modulation element has a sufficient response speed.

In addition, an input signal DV is inputted to the timing control circuit 12 and the display control circuit 16 from an external source. The timing control circuit 12 generates control signals C1 and C2 based on the input signal DV such that the data signal line drive circuit 18 outputs red, green and blue driving image signals to the data signal lines S1 to Sm during a period during which red, green, and blue LEDs (Light Emitting Diodes) 20r, 20g, and 20b included in the backlight unit 20 emit light. The timing control circuit 12 provides the control signal C1 to the display control circuit 16 and provides the control signal C2 to the backlight control circuit 13.

The display control circuit 16 generates video signals CV that allow corresponding pixel formation portions to light up during an appropriate subframe period, based on the input signal DV representing red (R), green (G), and blue (B) gray scale values, and provides the video signals CV to the data signal line drive circuit 18.

In addition, the display control circuit 16 generates a control signal (e.g., a gate clock signal) C3 for the scanning signal line drive circuit 17 and a control signal (e.g., a source clock signal) C4 for the data signal line drive circuit 18, based on the control signal C1 provided from the timing control circuit 12 and the input signal DV inputted from an external source.

The scanning signal line drive circuit 17 outputs active scanning signals in turn to the scanning signal lines G1 to Gn, based on the control signal C3. The data signal line drive circuit 18 generates driving image signals based on the video signals CV, and outputs the driving image signals to the data signal lines S1 to Sm at timing determined by the control signal C4. The driving image signals outputted to the data signal lines S1 to Sm are provided to signal holding capacitances 32 through TFTs 31 connected to an active one of the scanning signal lines G1 to Gn.

Each of the driving image signals written to the signal holding capacitances 32 has a voltage, either a high voltage or a low voltage, according to digital image data. The voltage is held and inputted to the optical modulation element 35 even after the TFT 31 is turned off. By the voltage, the optical modulation element 35 controls blockage or transmission of light from the backlight unit 20.

Here, the on state and off state of the optical modulation element 35 are controlled in a binary manner. By performing PWM (Pulse Width Modulation) modulation on a weighted light-emitting period (described later) which is provided to a driving image signal which is digital image data, 8-bit time division gray scale display can be performed. A specific description will be made later.

The backlight unit 20 includes the red LEDs 20r, the green LEDs 20g, and the blue LEDs 20b which are disposed two-dimensionally. The red LEDs 20r, the green LEDs 20g, and the blue LEDs 20b are independently connected to the power supply circuit 22 through the switch group 21. The backlight control circuit 13 generates a backlight control signal BC for appropriately turning on (bringing into a conduction state) each switch included in the switch group 21 for each color frame period which will be described later, based on the control signal C2 provided from the timing control circuit 12, and provides the backlight control signal BC to the switch group 21.

The switch group 21 connects one or more of the red LEDs 20r, the green LEDs 20g, and the blue LEDs 20b to the power supply circuit 22 at appropriate timing based on the backlight control signal BC, and thereby provides a power supply voltage. By this, one or more of the red LEDs 20r, the green LEDs 20g, and the blue LEDs 20b emit light in a manner described later, in accordance with timing at which driving image signals are applied to the data signal lines S1 to Sm, and irradiate one of red, green, and blue lights from the back of the display panel 11 for each color frame period.

Note that, as light sources included in the backlight unit 20, instead of the red, green, and blue LEDs 20r, 20g, and 20b, known light sources such as red, green, and blue CCFLs (Cold Cathode Fluorescent Lamps) may be used.

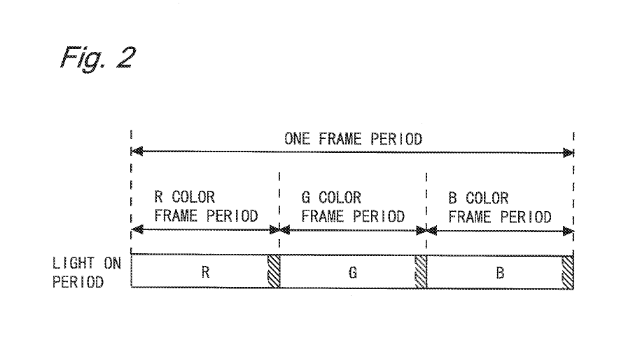

The display device 10 of the present embodiment performs color display using a field sequential color system by dividing one frame period into three color frame periods and displaying display colors which are assigned to the respective color frame periods, in an order shown in FIG. 2. In addition, by dividing a lighting period included in each color frame period into a plurality of subframe periods which are weighted in a manner described later, and allowing backlight light to be transmitted during appropriate subframe periods, gray scale display using a time division gray scale system is performed. First, display in each color frame period will be described with reference to FIG. 2.

### 1.2 Display in Each Color Frame Period

FIG. 2 is a diagram showing display colors and lighting periods thereof in the respective color frame periods. As shown in FIG. 2, one frame period is divided into three color frame periods, and almost the entire color frame period is a lighting period and a period between color frame periods is a non-lighting period serving as a vertical flyback interval. Note that the non-lighting period in FIG. 2 is a small portion of the second half, and the length thereof is not particularly limited and the non-lighting period can be omitted. In addition, the color frame periods are not limited to the above-described three colors and may be four or more colors, and if color display is not performed, then one or two colors may be used. Note that in the case of one color, since a color frame period and a frame period are the same, the system is not a field sequential system, but application of the present invention is not necessarily premised on a field sequential system.

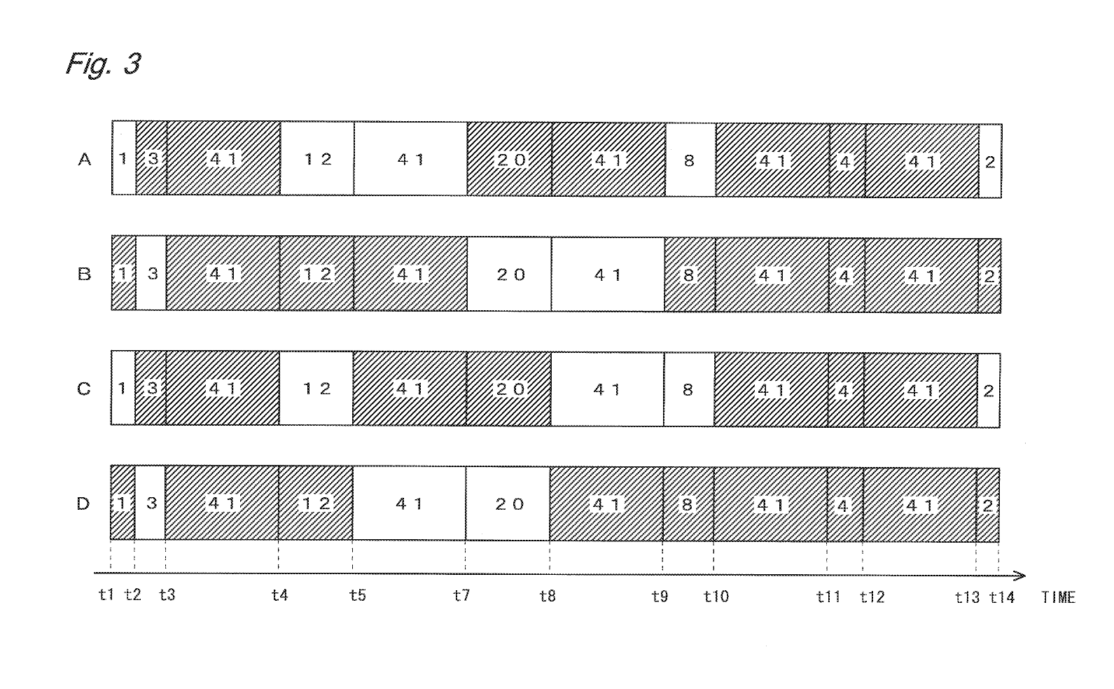

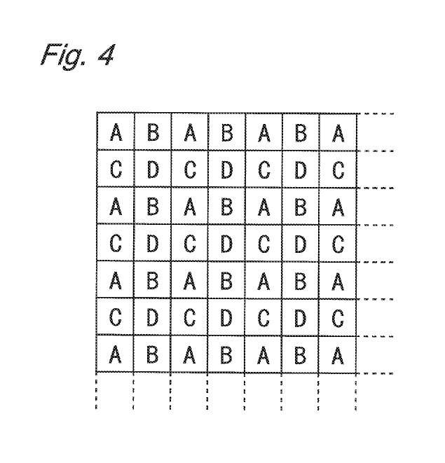

In the present embodiment, a display color assigned to an R color frame period is red (R), a display color assigned to a G color frame period is green (G), and a display color assigned to a B color frame period is blue (B). Here, since a time division gray scale system is implemented by dividing a lighting period included in each color frame period into a plurality of subframe periods of the same content, in the following, with reference to FIGS. 3 and 4, gray scale display of red pixels during the lighting period included in the R color frame period is described as an example, and description of green and blue is omitted.

FIG. 3 is a diagram showing four light-emitting patterns corresponding to four pixels from a pixel A to a pixel D during a lighting period included in an R color frame period. FIG. 4 is a diagram partially showing exemplary disposition of the light-emitting patterns of pixels. Here, A to D shown in FIG. 3 indicate the types of light-emitting patterns. The light-emitting patterns A to D correspond to the pixels A to D, and the (unit) length of each of a plurality of subframe periods for when the length of each of 255 periods into which each lighting period is divided is a length of one unit is indicated by a number. Note that for convenience of description, each length differs from the actual length and is indicated appropriately. Note also that here the lighting period is divided into 255 periods so as to perform 256 gray scale representation, and thus, when the number of gray scales to be represented is different, an appropriate number of divisions can be set accordingly.

In FIG. 3, hatched subframe periods indicate subframe periods during which light emission (lighting) is not performed (hereinafter, referred to as “non-light-emitting subframe periods”) and unhatched subframe periods indicate subframe periods during which light emission (lighting) is performed (hereinafter, referred to as “light-emitting subframe periods”).

Here, in the light-emitting patterns A to D corresponding to the pixels A to D, subframe periods are arranged in the same order and with the same lengths. For example, the first subframe period has a length of one unit from time t1 to time t2, and the next subframe period has a length of three units from time t2 to time t3. The reason that as such the lengths of subframe periods are not changed but only the positions of light-emitting subframe periods are changed in all light-emitting patterns is because selection of light-emitting subframe periods according to display gray scale is facilitated. Therefore, the length of each subframe period may be changed. Note that the lengths of subframe periods shown in FIG. 3 are exemplification and thus any known combination (of lengths) may be used.

In addition, the sum total of light-emitting subframe periods (the sum of the lengths of all light-emitting subframe periods) is the same between the light-emitting patterns, and light-emitting subframe periods are selected so as to display the same gray scale, here, 64 gray scale (a gray scale value of 64). However, as can be seen by referring to the drawing, light-emitting subframe periods are selected such that one or more light-emitting subframe periods and one or more non-light-emitting subframe periods differ between the light-emitting patterns.

Note that although here the light-emitting patterns A to D for displaying 64 gray scale are exemplified, in practice, light-emitting patterns A to D are set for all cases of displaying 0 to 255 gray scales, and they are stored in a predetermined memory in the form of a correspondence table, a calculation formula, etc. Note also that although, in the following, for convenience of description, the light-emitting patterns A to D where the pixels A to D display the same gray scale are exemplified, in practice, in many cases, there is a one to about several display gray scales difference between the pixels A to D. Even in that case, light-emitting patterns corresponding to gray scale to be displayed are selected.

Here, in the light-emitting pattern A corresponding to the pixel A, selection is made such that the number of light-emitting subframe periods to be selected to display target gray scale (here, 64 gray scale) is largest (here, five light-emitting subframe periods). By thus setting a light-emitting pattern, the positions of light-emitting subframe periods are appropriately distributed within one frame period (to be exact, a lighting period included in an R color frame period). Thus, the possibility that, when the line of sight moves from the pixel A, the line of sight moves only to a “non-light-emitting subframe period” portion decreases (i.e., when the line of sight moves, the overall amount of gray scale change decreases). As a result, contouring can be suppressed.

In addition, in the light-emitting pattern B corresponding to the pixel B, the positions of light-emitting subframe periods are selected such that the positions of light-emitting subframe periods differ most from the positions of the light-emitting subframe periods in the light-emitting pattern A (such that the number of the positions differing from those in the light-emitting pattern A is large). By thus setting the light-emitting patterns A and B, when the line of sight moves between the pixels A and B, since the positions of light-emitting subframe periods differ between the pixels A and B, the possibility that the line of sight moves only to a “non-light-emitting subframe period” portion decreases (i.e., when the line of sight moves, the overall amount of gray scale change decreases). As a result, contouring can be suppressed.

Furthermore, as shown in FIG. 3, of the subframe periods disposed in the light-emitting patterns A and B (and the light-emitting patterns C and D which will be described later), the longest subframe periods are four subframe periods with a length of 41 units. Two of them are light-emitting subframe periods, and the light-emitting subframe periods are disposed near the center (of the lighting period included in the R color frame period). By thus disposing the longest light-emitting subframe periods near the center, a temporal light emission barycenter does not move, and thus, a point of the occurrence of contouring can be distributed to a location other than the center (to be exact, a point in time other than the center). As a result, (regarding the movement of the line of sight between the pixels A and B) contouring for the entire frame period can be suppressed.

Next, the light-emitting pattern C corresponding to the pixel C has disposition where only the position of the longest light-emitting subframe period in the light-emitting pattern A corresponding to the pixel A is changed, and the light-emitting pattern D corresponding to the pixel D has disposition where only the position of the longest light-emitting subframe period in the light-emitting pattern B corresponding to the pixel B is changed. By such disposition, contouring can be suppressed not only for the movement of the line of sight between the pixels A and B, but also for the movement of the line of sight between the pixels A and C and the movement of the line of sight between the pixels B and D.

Note that even if the light-emitting pattern A corresponding to the pixel A and the light-emitting pattern B corresponding to the pixel B are switched each other, or the light-emitting pattern C corresponding to the pixel C and the light-emitting pattern D corresponding to the pixel D are switched each other, or both are switched each other, the same effect can be provided. Note also that even if the light-emitting pattern A corresponding to the pixel A and the light-emitting pattern C corresponding to the pixel C are switched each other, or the light-emitting pattern B corresponding to the pixel B and the light-emitting pattern D corresponding to the pixel D are switched each other, or both are switched each other, the same effect can be provided with only the direction of the movement of the line of sight being different, left-right or up-down.

### 1.3 Effect of the First Embodiment

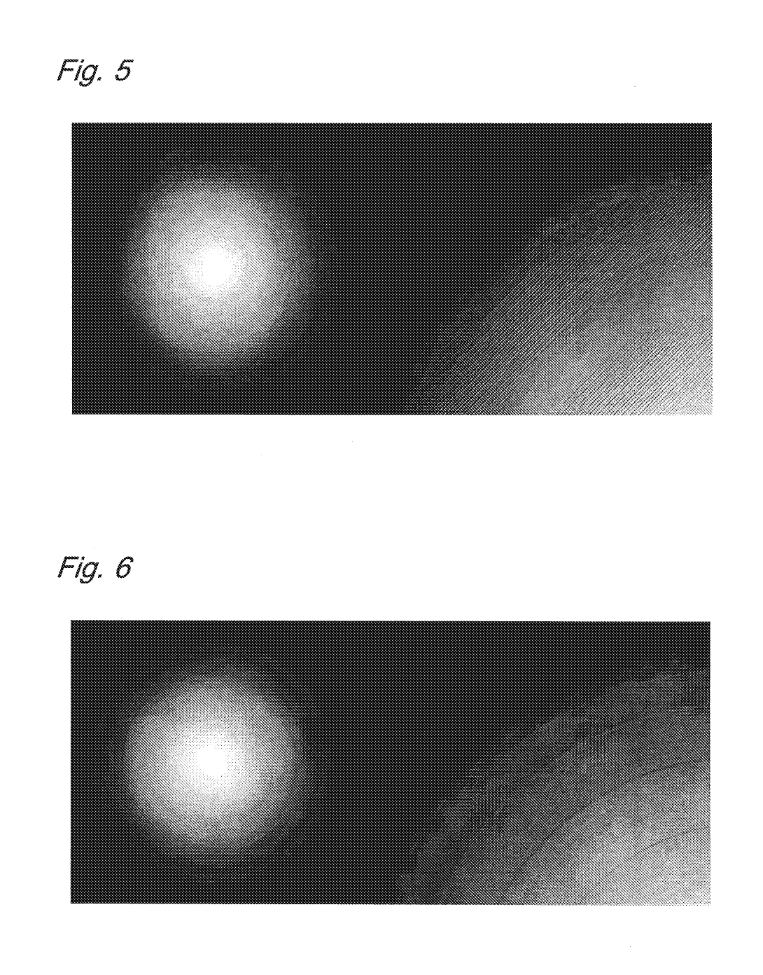

As described above, in the display device 10 of the present embodiment, as shown in FIG. 3, light-emitting subframe periods are selected such that one or more light-emitting subframe periods and one or more non-light-emitting subframe periods differ between the light-emitting patterns corresponding to the pixels A to D. Thus, a spatial location of the occurrence of contouring can be distributed, enabling to suppress overall contouring. The matter that the occurrence of contouring can be thus suppressed will be described with reference to FIGS. 5 and 6.

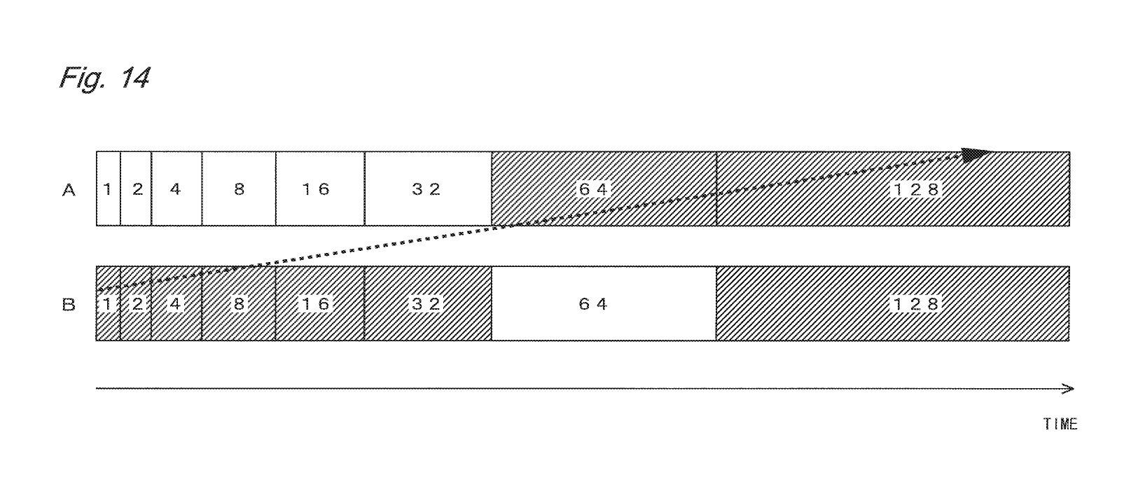

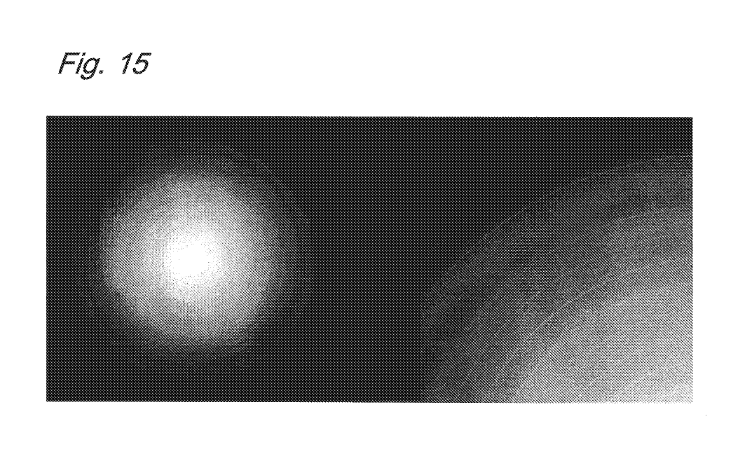

As with FIG. 15, FIG. 5 is a diagram showing contouring which is visualized based on simulation computation. As with FIG. 15, simulation in this FIG. 5 is computed and displayed such that brightnesses that are recognized when the line of sight moves from a left pixel to a right pixel of two left-right adjacent pixels (e.g., the one shown in FIG. 14) are represented as the actual brightnesses of the pixels. As shown in this FIG. 5, it can be seen that, when a sphere whose luminance gradually changes is displayed, contouring that occurs near predetermined gray scales such as that shown in FIG. 15 is not seen and the occurrence of contouring is suppressed or eliminated.

In addition, FIG. 6 is a diagram showing contouring which is visualized based on simulation computation for a case of performing gray scale display using the same light-emitting pattern for all pixels, unlike the case of the present embodiment. As can be seen by comparing FIGS. 6 and 5, it can be seen that, when gray scale display is performed using the same light-emitting pattern, a spatial location of the occurrence of contouring cannot be distributed, and thus, contouring occurs.

### 2. Second Embodiment

### 2.1 Configuration of a Display Device

An overall configuration of a display device using a field sequential system and a time division gray scale system according to a second embodiment of the present invention is the same as that for the case of the first embodiment (see FIG. 1) and the same operation is performed except that correspondences between pixels and light-emitting patterns are changed every frame period (or every color frame period), and thus, description thereof is omitted.

### 2.2 Correspondences Between Pixels and Light-Emitting Patterns

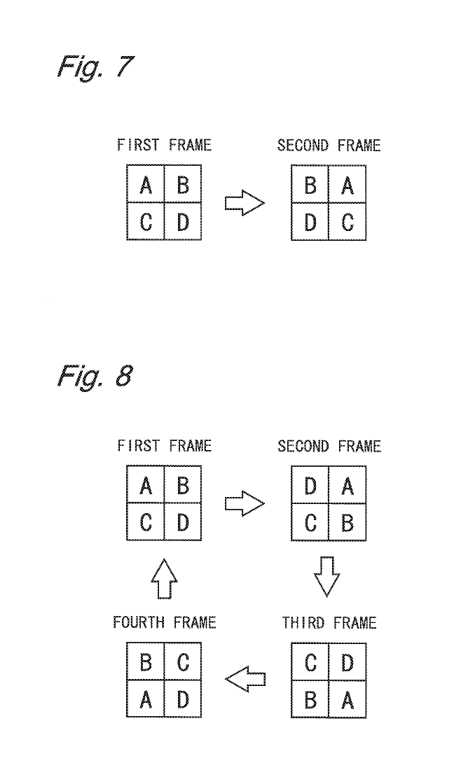

FIG. 7 is a diagram showing an example of correspondences between pixels and light-emitting patterns for a first frame and a second frame. Note that A to D in the drawing indicate light-emitting patterns but not pixels A to D.

As shown in FIG. 7, in the first frame, as in the case of the first embodiment, an upper-left pixel uses a light-emitting pattern A, an upper-right pixel uses a light-emitting pattern B, a lower-left pixel uses a light-emitting pattern C, and a lower-right pixel uses a light-emitting pattern D. In the next second frame, however, the upper-left pixel uses the light-emitting pattern B, the upper-right pixel uses the light-emitting pattern A, the lower-left pixel uses the light-emitting pattern D, and the lower-right pixel uses the light-emitting pattern C. By thus switching the light-emitting patterns of the left and right pixels each other every frame, the location of the occurrence (the point in time of the occurrence) of contouring can be distributed temporally, too. As a result, the occurrence of contouring can be further suppressed over the case of the first embodiment.

Note that the above-described first and second frames represent first and second consecutive frame periods, but may be consecutive color frame periods (included in the same frame period). In this case, the occurrence of contouring based on changes in color occurring between colors instead of based on differences in the brightness and darkness of color pixels can be suppressed.

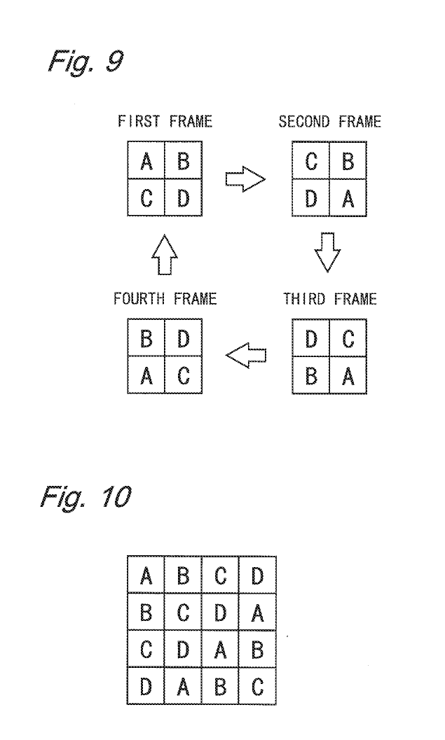

Such a technique for temporally distributing the occurrence of contouring is not limited to the case of FIG. 7, and various known changing modes can be applied, by which the same effect can be obtained. In addition, for example, as shown in FIGS. 8 and 9, correspondences between pixels and light-emitting patterns may be changed between four consecutive frames instead of two consecutive frames.

FIG. 8 is a diagram showing an example in which correspondences between pixels and light-emitting patterns are changed by rotation from a first frame to a fourth frame. As shown in FIG. 8, in a configuration in which light-emitting patterns corresponding to four pixels are changed by clockwise rotation, light-emitting patterns corresponding to pixels located on a diagonal line are always the same. Therefore, without destroying a combination of light-emitting patterns that are set to suppress the occurrence of contouring when the line of sight moves in an up-down or left-right direction, the occurrence of contouring can be effectively suppressed.

FIG. 9 is a diagram showing an example in which correspondences between pixels and light-emitting patterns are randomly changed from a first frame to a fourth frame. By thus setting randomly, a periodic change does not occur and thus the (possible) occurrence of contouring by combining a specific light-emitting pattern with a specific pixel can be suppressed.

Note that although the above-described embodiment describes the case in which the number of consecutive frames is two or four, the number of consecutive frames may be three or five or more.

<2.3 Effect of the Second Embodiment>

As described above, in the display device 10 of the present embodiment, light-emitting subframe periods are selected such that one or more light-emitting subframe periods and one or more non-light-emitting subframe periods for the same pixel differ between two or more consecutive frames. Thus, the occurrence of contouring can be distributed temporally, enabling to suppress contouring for all of a plurality of frames.

### 3. Third Embodiment

### 3.1 Configuration of a Display Device

An overall configuration of a display device using a field sequential system and a time division gray scale system according to a third embodiment of the present invention is the same as that for the case of the first embodiment (see FIG. 1) and the same operation is performed except that there are five or more types of light-emitting patterns or there are five or more corresponding pixels, and thus, description thereof is omitted. With reference to FIGS. 10 to 13, examples will be described below.

### 3.2 Correspondences Between Pixels and Light-Emitting Patterns

FIG. 10 is a diagram showing an example of correspondences between 16 pixels adjacent to each other in a row direction and a column direction and four light-emitting patterns. Note that A to D in the drawing indicate light-emitting patterns but not pixels A to D. By thus appropriately assigning the four light-emitting patterns to the 16 pixels, the occurrence of contouring is spatially distributed, enabling to suppress overall contouring.

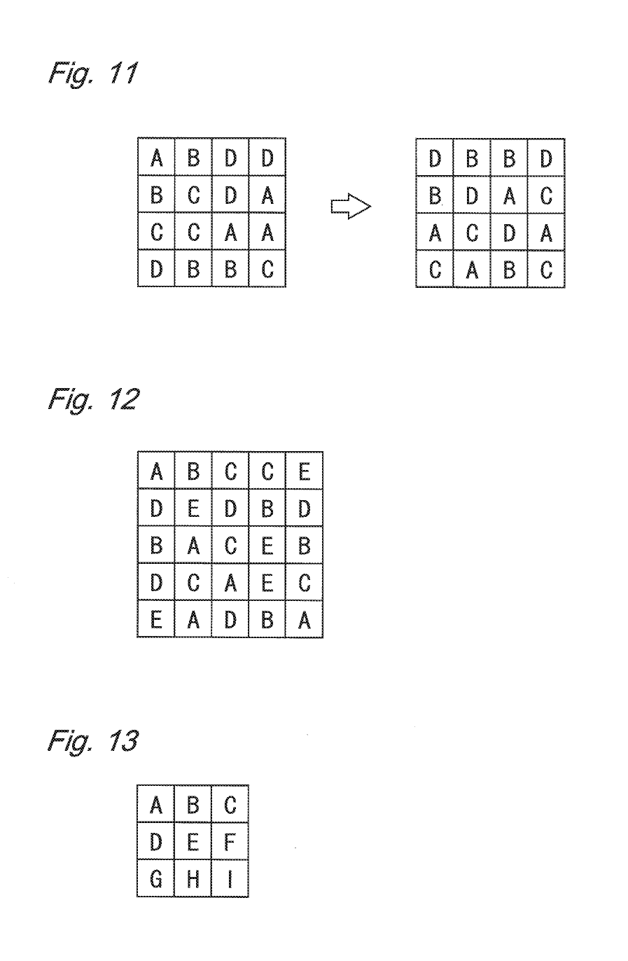

FIG. 11 is a diagram showing an example of correspondences between pixels and light-emitting patterns for a first frame and a second frame. In FIG. 11, too, correspondences between 16 pixels adjacent to each other in a row direction and a column direction and four light-emitting patterns are set, and the correspondences may be set so as to differ between the first frame and the second frame. By doing so, the occurrence of contouring is distributed temporally, too, and thus, contouring can be further suppressed. Note that furthermore the correspondences may be set so as to differ between three or more frames, or the number of corresponding pixels or light-emitting patterns may differ from that described above.

FIG. 12 is a diagram showing an example of correspondences between 25 pixels adjacent to each other in a row direction and a column direction and five light-emitting patterns. Note that A to E in the drawing indicate light-emitting patterns. By thus appropriately assigning the five light-emitting patterns to the 25 pixels, the occurrence of contouring is spatially distributed and thus overall contouring can be suppressed.

FIG. 13 is a diagram showing an example of correspondences between nine pixels adjacent to each other in a row direction and a column direction and nine light-emitting patterns. Note that A to I in the drawing indicate light-emitting patterns. By thus appropriately assigning the light-emitting patterns, the occurrence of contouring is spatially distributed and thus overall contouring can be suppressed.

### 4. Other Variants

Although the above-described embodiments describe, as an example, a display including shutter elements, any display device may be used as long as the display device adopts a time division gray scale system. For example, the present invention can be likewise applied to a display device using a PDP system.

### INDUSTRIAL APPLICABILITY

Display devices of the present invention have features that they are capable of representing high gray scale and sufficiently suppressing the occurrence of contouring, and thus can be used as various types of display devices that perform display using a time division gray scale system, such as a display device including shutter elements and a display device using a PDP system.

### DESCRIPTION OF REFERENCE CHARACTERS

10: DISPLAY DEVICE
11: DISPLAY PANEL
13: BACKLIGHT CONTROL CIRCUIT
16: DISPLAY CONTROL CIRCUIT
17: SCANNING SIGNAL LINE DRIVE CIRCUIT
18: DATA SIGNAL LINE DRIVE CIRCUIT
20: BACKLIGHT UNIT
21: SWITCH GROUP
30: PIXEL FORMATION PORTION
35: OPTICAL MODULATION ELEMENT
C1 to C4: CONTROL SIGNAL
BC: BACKLIGHT CONTROL SIGNAL
G1 to Gn: SCANNING SIGNAL LINE
S1 to Sm: DATA SIGNAL LINE
DV: DATA SIGNAL
CV: VIDEO SIGNAL

1. A display device that performs pixel-by-pixel gray scale display by dividing a unit frame period into subframe periods with a plurality of types of length and controlling whether to allow a pixel to emit light, on a subframe-period-by-subframe-period basis, the display device comprising:
a display panel including a plurality of pixel formation portions arranged in a matrix form in a column direction and a row direction;
a display control circuit that outputs, based on an input signal, data signals for controlling whether to allow each of the plurality of pixel formation portions to emit light, on a subframe-period-by-subframe-period basis; and
a drive circuit that drives the plurality of pixel formation portions based on the data signals, wherein
the display control circuit:
has, for each gray scale, first to fourth different light-emitting patterns as light-emitting patterns indicating whether to allow a pixel to emit light during each of the plurality of subframe periods included in the unit frame period; and
assigns two or more of the first to fourth light-emitting patterns to four pixel formation portions included in each of sets, each of the sets including four pixel formation portions arranged in a matrix form and two of the four pixel formation portions being arranged adjacent to each other in the column direction and the row direction, and outputs, as the data signals, signals for controlling whether to allow each of the pixel formation portions to emit light according to the assigned light-emitting patterns.

2. The display device according to claim 1, wherein the display control circuit assigns the first to fourth light-emitting patterns to the four pixel formation portions such that, when there are a plurality of longest subframe periods in the first to fourth light-emitting patterns and when a pixel is allowed to emit light during at least one of the plurality of longest subframe periods and a pixel is not allowed to emit light during the at least one of the plurality of longest subframe periods, the longest subframe period during which a pixel is allowed to emit light differs between two pixel formation portions adjacent to each other in the row direction and differs between two pixel formation portions adjacent to each other in the column direction.

3. The display device according to claim 2, wherein the display control circuit assigns the first to fourth light-emitting patterns having the longest light-emitting subframe periods near a center of the unit frame period, to the four pixel formation portions.

4. The display device according to claim 2, wherein the display control circuit assigns the first light-emitting pattern having a largest number of light-emitting subframe periods, the second light-emitting pattern having a largest number of light-emitting subframe periods that differ from the light-emitting subframe periods in the first light-emitting pattern, the third light-emitting pattern that differs from the first light-emitting pattern only in the longest light-emitting subframe period, and the fourth light-emitting pattern that differs from the second light-emitting pattern only in the longest light-emitting subframe period, to the four pixel formation portions, the light-emitting subframe periods being subframe periods during which a pixel is allowed to emit light.

5. The display device according to claim 1, wherein the display control circuit assigns the first to fourth light-emitting patterns to the four pixel formation portions such that one or more of the first to fourth light-emitting patterns differ between two consecutive unit frame periods.

6. The display device according to claim 5, wherein the display control circuit assigns the first to fourth light-emitting patterns to the four pixel formation portions such that one or more of the first to fourth light-emitting patterns differ between four consecutive unit frame periods.

7. The display device according to claim 1, wherein the display control circuit assigns the first to fourth light-emitting patterns to a pixel formation portion group included in each of sets, each of the sets including a pixel formation portion group where one or more pixel formation portions adjacent to any of the four pixel formation portions are added.

8. The display device according to claim 7, wherein the display control circuit further has one or more light-emitting patterns differing from the first to fourth light-emitting patterns, and assigns the five or more light-emitting patterns to the pixel formation portion group.

9. A display method that performs pixel-by-pixel gray scale display by dividing a unit frame period into subframe periods with a plurality of types of length and controlling whether to allow a pixel to emit light, on a subframe-period-by-subframe-period basis, the display method comprising:
a display controlling step of outputting, based on an input signal, data signals to a display panel including a plurality of pixel formation portions arranged in a matrix form in a column direction and a row direction, the data signals controlling whether to allow each of the plurality of pixel formation portions to emit light, on a subframe-period-by-subframe-period basis; and
a driving step of driving the plurality of pixel formation portions based on the data signals, wherein
the display controlling step:
has, for each gray scale, first to fourth different light-emitting patterns as light-emitting patterns indicating whether to allow a pixel to emit light during each of the plurality of subframe periods included in the unit frame period; and
assigns two or more of the first to fourth light-emitting patterns to four pixel formation portions included in each of sets, each of the sets including four pixel formation portions arranged in a matrix form and two of the four pixel formation portions being arranged adjacent to each other in the column direction and the row direction, and outputs, as the data signals, signals for controlling whether to allow each of the pixel formation portions to emit light according to the assigned light-emitting patterns.
